(19) United States
(12) Patent Application Publication
(10) Pub. No.: US 2013/0097552 A1
(43) Pub. Date: Apr. 18, 2013

(54) CONSTRUCTING AN ANIMATION TIMELINE VIA DIRECT MANIPULATION

(71) Applicants: Shawn Alan Villaron, San Jose, CA (US); Hannes Ruescher, Palo Alto, CA (US); Jeffrey Edwin Murray, Mountain View, CA (US); Jeffrey Chao-Nan Chen, Cupertino, CA (US); Andreas Markus Scheidegger, San Jose, CA (US); Christopher Michael Maloney, San Francisco, CA (US); Ryan Charles Hill, Mountain View, CA (US)

(72) Inventors: Shawn Alan Villaron, San Jose, CA (US); Hannes Ruescher, Palo Alto, CA (US); Jeffrey Edwin Murray, Mountain View, CA (US); Jeffrey Chao-Nan Chen, Cupertino, CA (US); Andreas Markus Scheidegger, San Jose, CA (US); Christopher Michael Maloney, San Francisco, CA (US); Ryan Charles Hill, Mountain View, CA (US)

(73) Assignee: Microsoft Corporation, Redmond, WA (US)

(21) Appl. No.: 13/275,327

(22) Filed: Oct. 18, 2011

(51) Int. Cl. G06F 3/048

(52) U.S. Cl. 715/781

(57) ABSTRACT

A presentation program provides an authoring tool allowing users to indicate animation sequences to be applied to an object in a document for purposes of creating or editing animation sequences. The user can directly manipulate the object on an editing pane, and the manipulations are interpreted as applying an animation class type. Different animation effects can be further associated with object for the particular animation class type. The user can select a particular animation effect and define the layout as a key frame that defines the animation sequence to be applied to the object at a given time during playback. The user can further manipulate the object and define subsequent key frames, and upon playback, the presentation program will interpolate the locations of the object between key frames as necessary. The user can further define the time period between key frames that is to be applied during playback.

### BACKGROUND

Desktop productivity software allows users to create visual presentations, sometimes referred to as “slide shows.” One such program is the PowerPoint® application program from Microsoft® Corporation. Presentation programs allow a sequence of slides to be first prepared and then viewed. The slides typically incorporate objects in the form of text, images, icons, charts, etc. In addition to static presentation of such objects on a slide, presentation programs allow portions of the presentation to be animated. Specifically, objects on a particular slide can be animated. Animation features include: moving text, rotating objects, changing color or emphasis on an object, etc. When the slide presentation is viewed, the animation sequences can be an effective tool for enhancing portions of the presentation to the viewers.

While a well-prepared presentation with animation appears seamless and can enhance the presentation, a poorly prepared animated presentation may detract from the presentation. Authoring animation sequences on a slide may be time consuming, and the process may not always be intuitive to the user, leading to creating a poor animation sequence. Typically, preparing an animation sequence requires a number of steps to create the animation. Frequently, the author must repeatedly review the animation during the authoring phase in order to edit the animation sequence to obtain the desired animation result. This process can be time consuming, and may require special training by the user to accomplish the desired animation. A faster, more intuitive approach for authoring animation sequences would facilitate the animation authoring experience.

It is with respect to these and other considerations that the disclosure made herein is presented.

### SUMMARY

Concepts and technologies are described herein for facilitating authoring an animation sequence involving an object in a document, such as on a slide in a presentation program. Objects to be animated may have various animation characteristics defined by the user by directly manipulating the object using existing object manipulation tools. These manipulations can be associated with a key frame of a particular slide. Allowing the user to directly manipulate the objects facilitates defining the animation sequences for the objects. The present program then generates and stores a prescriptive script comprising of animation descriptors that define the animation sequences associated with the objects.

In one embodiment, a method defines an animation sequence and includes the operations of providing an editing pane and an animation script pane to a user via a graphical user interface on a computing device, and receiving input from the user identifying an object to which the animation sequence is to be applied to. The method then involves receiving input from the user manipulating the object within the editing pane, interpreting manipulation of the object as one of a plurality of animation class types, and receiving input from the user requesting setting a first key frame. Then, the animation script pane is updated by providing an animation descriptor of the animation sequence to be applied to the object when the object is animated.

In another embodiment, a computer-readable storage medium having computer-readable instructions stored thereupon which, when executed by a computer, cause the computer to provide an editing pane and an animation script pane to a user via a graphical user interface on a computing device, receive input from the user identifying an object to which the animation sequence is to be applied to, and receive input from the user manipulating the object within the editing pane. The instructions, when executed, further cause the computer to interpret the input from the user manipulating the object as one of a plurality of animation class types, and receive input from the user requesting a setting of a first key frame. Finally, the instructions further cause the computer to update the animation script pane by providing an animation descriptor of the animation sequence to be applied to the object.

In another embodiment, a system for defining an animation sequence of an object includes a network interface unit connected to a communications network configured to receive user input from a computer pertaining to defining the animation sequence, and a memory configured to store data representing the object to which the animation sequence is to be associated with. The system further includes a processor that is configured to provide an editing pane and an animation script pane to the user, receive a first input from the user identifying the object to which the animation sequence is to be applied to, and receive a second input from the user manipulating the object within the editing pane.

The processor is further configured to interpret the second input from the user manipulating the object as one of a plurality of animation class types, receive a request from the user requesting setting a first key frame, and in response to receiving the request, update the animation script pane by indicating a first animation descriptor of the animation sequence to be applied to the object when the object is animated. The processor is further configured to interpret a third input from the user manipulating the object as another one of a plurality of animation class types, receive a second input from the user requesting a setting of a second key frame, and in response to receiving the another request, update the animation script pane by providing a second animation descriptor of the animation sequence to be applied to the object.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic diagram showing one context of a system for authoring animation of objects in a slide as provided in one embodiment presented herein;

FIG. 2 is a schematic diagram illustrating an animation of a single object using key frames in accordance with one embodiment disclosed herein;

FIG. 3 is a schematic diagram illustrating a parallel animation sequence of two objects using key frames in accordance with one embodiment disclosed herein;

FIG. 4 is a schematic diagram illustrating a serial animation sequence involving two objects in accordance with one embodiment disclosed herein;

FIG. 5 is a schematic diagram illustrating various times associated with key frames according to one embodiment presented herein;

FIGS. 6A-6E illustrate a user interface associated with authoring animation sequences involving various key frames according to one embodiment presented herein;

FIG. 7 is a process flow associated with authoring an animation for an object according to one embodiment presented herein;

FIG. 8 is an illustrative user interface associated with indicating times associated with key frames according to one embodiment presented herein;

FIG. 9 illustrates one embodiment of a computing architecture for performing the operations as disclosed according to one embodiment presented herein; and

FIG. 10 illustrates one embodiment of direct manipulation of an object by a user using a touch screen as disclosed according to one embodiment presented herein.

### DETAILED DESCRIPTION

The following detailed description is directed to an improved animation sequence authoring tool for animating objects in a document, such as an object in a slide generation/presentation program. Specifically, the creation and editing of animation sequences is facilitated by a user being able to define key frames by explicitly indicating the creation of such and directly manipulating objects presented in the key frames. Directly manipulating an object includes using a pointer to select and position an object within an editing pane. The authoring tool then converts the user's actions into a prescriptive language based on a set of animation primitives. These animation primitives can be stored and then executed when presenting the animation sequence during presentation of the slides. Further, the prescriptive language can be backwards compatible with presentation programs that do not have the disclosed animation sequence authoring tool. This allows users to prepare a slide presentation with an animation sequence using the improved authoring tool in a presentation program, and present the slide presentation using another version of the slide presentation program that may not necessarily incorporate the improved authoring tool.

In the following detailed description, references are made to the accompanying drawings that form a part hereof, and which are shown by way of illustration specific embodiments or examples. Referring now to the drawings, in which like numerals represent like elements throughout the several figures, aspects of a system for facilitating creation of animation effects in a slide program. In several instances, distinct animation sequences will be presented that use similar shaped icons. For clarity, these similarly shaped icons are referenced with different numbers when they appear in different animation sequences.

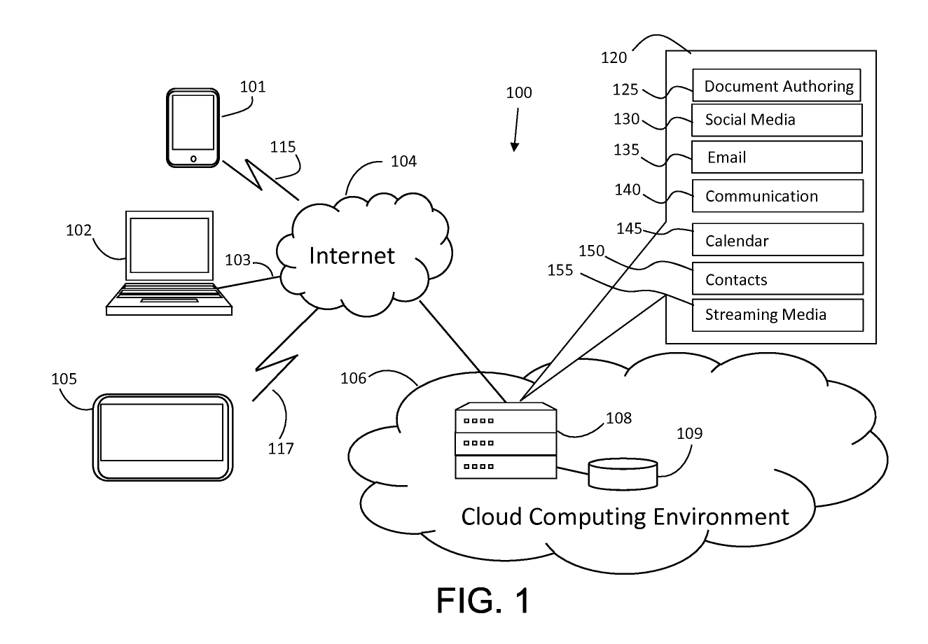

One context for performing the processes described herein is shown in FIG. 1. FIG. 1 shows one embodiment of a context for authoring animation sequences. In FIG. 1 a user's processing device, such as a laptop computer 102 or desktop computer accesses a communications network 104, such as the Internet using a wired connection 103. In other embodiments, wireless data transmission technology could be used in lieu of a wired connection. In other embodiments, the user may use a processing device comprising a smart-phone type of device 101 using a cellular type wireless connection 115 or a mobile computing device 105, such as a tablet computing device, which can also use wireless data transmission technology 117, to access the communications network 104. Other types of computing devices and communications networks can be used as well.

The computer processing devices 101, 102, or 105 access a server 108 in a cloud computing environment 106 that can access data in a storage device 109. The storage device 109 may store data associated with the various applications, in addition to maintaining documents for the user. The server 108 can host various applications 120, including a document authoring program 125 that the user can access using computer processing devices 101, 102 or 105. The server 108 may implement the methods disclosed herein for animating timelines in a presentation document. Thus, the principles and concepts discussed above are not limited to execution on a local computing device.

The server 108 may execute other applications for the user, including social media applications 130, email applications 135, communication applications 140, calendar applications 145, contact organization applications 150, as well as applications providing access to various types of streaming media. Any of these and other applications can utilize the concepts disclosed herein as applicable.

In other embodiments, the user may execute an application program comprising a slide presentation program locally, i.e., on the computing device 101, 102, or 105 without accessing the cloud computing environment 106. The application program may be executed on a processor in the smart-phone 101, laptop 102, or tablet computer 105, and data may be stored on a hard disk or other storage memory in the processing device. Other configurations are possible for performing the processes disclosed herein.

In one embodiment, the application program referenced above is a slide presentation program (“presentation program”) allowing the creation and playback of a slide presentation. A slide presentation includes a series of slides where each slide typically includes visual objects (“objects”) such as text, images, charts, icons, etc. Slides can also incorporate multi-media visual objects such as video, audio, and photos. The creation or authoring of a slide involves the user defining what objects are included in a slide. Typically, a series of slides are created for a given presentation.

The presentation program also allows the playback of the slides to an audience. Thus, the presentation program referenced herein allows both authoring of a slide with an animation sequence, and playback of the slide comprising the animation sequence. Reference to the program as a “presentation program” should not be construed as limiting the user from authoring the slide presentation. It is assumed that the presentation program has both an authoring mode and a playback mode.

The visual objects defined on a slide are often static—e.g., during the playback or presentation of the slide, the object is statically displayed on a given slide. However, visual objects can also be animated. The animation applied to an object, or set of objects, on a slide is referred to herein as an “animation sequence.” During the playback mode, the animated object may move or exhibit some other real-time modification to the object.

An animation effect refers to a particular form of the real-time modification applied to the object. Animation effects can be classified as being one of four different types or classes to aid in illustrating the principles herein. These are: entrance, emphasis, exit, and motion. Within each animation effect classification type, there is a plurality of animation effects. In many cases, the animation effect may be unique to a particular animation class, so that reference to the particular animation effect may unambiguously identify the animation class. In other cases, the animation effect may apply to different animation classes, so that identification of the animation effect may not unambiguously identify the animation class involved. It should be obvious from the context herein what animation class is involved, if it is not explicitly mentioned.

The entrance animation class refers to animation effects that introduce the object in a slide. All objects presented in an animation sequence must be introduced at some point and an object can be introduced in various ways. A text object, for example the title for a slide, can be animated to simply appear in its final position shortly after the slide is initially presented. Typically, there is a short time delay from the presentation of the slide to the introduction of the animated visual object, since if the object were to appear at the same time the slide appears, the entrance effect cannot be detected by the viewer. Other animation effects associated with the entrance animation class include: dissolve-in, peek-in, fly-in, fade-in, bounce-in, zoom-in, and float-in. Other animation effects involve presenting the visual object by showing portions thereof in conjunction with different patterns, including a box, circle, blinds, checkerboard, diamond, and random bars. Still other entrance animation class effects involve presenting the object by wiping, splitting, swiveling, revolving, or otherwise revealing portions of the object in some manner. Those skilled in the art will readily recognize that other effects may be defined.

The emphasis animation class involves animation effects that modify an existing visual object. The modification effect is often temporary and occurs for a defined time period, usually a few seconds. In other embodiments, the animation effect is applied and remains for the duration of the slide. The object may be made to change its shape or size, including grow/shrink, pulse, rotate, spin, or otherwise change. The object may be made to change its color including lightening, darkening, changing saturation levels, changing to complementary colors, etc.

The exit animation class involves animation effects that remove the object from the slide. In general, any of the animation effects associated with introducing the object (e.g., an entrance animation class) can be used in the exit animation class. For example, an object can be made to exit in position by fading-out, wiping-out, splitting, applying a pattern, etc. In other embodiments, the object can be made to exit with motion, e.g., flying-out, bouncing-out, etc.

The last animation class involves motion. Specifically, the object is moved along a motion path. The various animation effects essentially define the motion path. The motion path can be in a circle, oval, square, star, triangle, or any other shape. The motion path can be an arc, curvy pattern, a bouncing pattern, or a user-defined pattern. The object often, but not necessarily, begins and ends at different locations on the slide.

Those skilled in the art will readily recognize that for each animation class, additional animation effects can be defined. The above list is not intended to be exhaustive nor a requirement that each animation effect be included in the animation class.

The definition of the animation sequence to be applied to an object in the playback mode occurs in the authoring mode. The authoring mode is the phase in which the slides are created and is logically distinct from the presentation phase, which is when the slides are presented. Authoring the slideshow involves indicating various information about the animation sequence by the user (e.g., when the animation sequences are applied and to what objects on which slides), whereas presenting the slides presents the slides along with any associated animation.

The authoring of a slide presentation could occur using one computer, and the presentation could occur using another computer. For example, returning to FIG. 1, a laptop 102 by itself could be used to author a program, and a cloud computing environment 106 could be used to playback the presentation. Further, it is possible that different versions of the same presentation program are used to author the animation and to playback the presentation. A first user may author the slides using one version of the presentation program, and have the slideshow viewed by another user using another version (perhaps an older version) of the presentation program.

When the user authors an animation sequence, the user is providing information defining the animation that is to appear in the playback mode. During the authoring mode, the presentation program may mimic the object's animation that appears during the presentation mode. However, as will be seen, defining the animation that is to be shown can be time consuming and counter-intuitive.

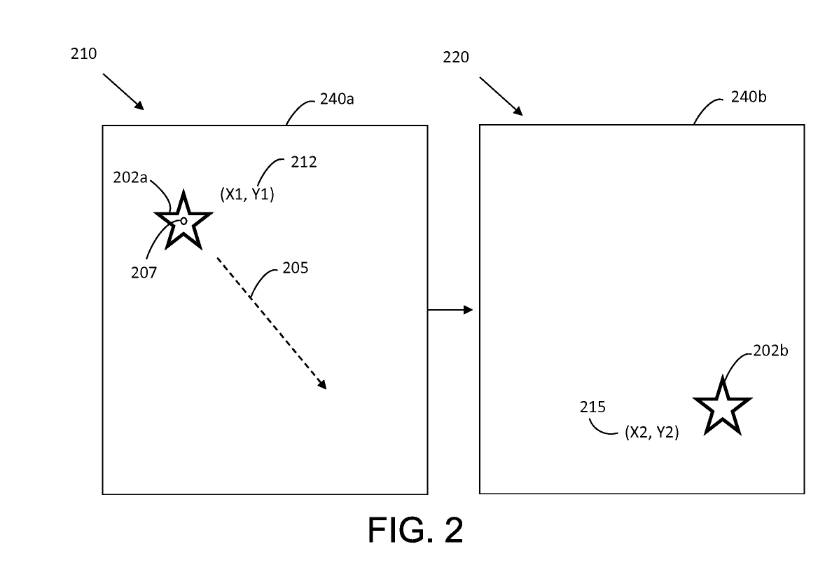

Authoring the animation inherently involves describing effects that are applied to an object in real-time over a time period. In a relatively simple application, the animation sequence can involve applying a single animation effect to a single object. This is illustrated in FIG. 2. FIG. 2 illustrates a portion of the slide 240a, 240b at two different points in time. Specifically, the slide 240a on the left side of FIG. 2 is associated with a first point in time, and the slide 240b on the right of FIG. 2 is associated with a subsequent point in time. For reference purposes, the slide and its associated objects with their respective locations may be simply referred to as key frame 1 210 and key frame 2 220.

Key frame 1 210 shows an icon comprising a 5-sided star object 202a. The star object's position in key frame 1 210 is centered over a coordinate point 207 in the upper left corner of the slide 240a, denoted as (X1, Y1) 212. The coordinate point 207, nor its (X1, Y1) 212 representation, is not seen by the user, but is shown for purposes of referencing a location of the star icon 202a. The coordinate point could have been instead selected based on some other location on the icon, such as the point of one of the arms of the star icon.

The animation associated with the visual object 202a involves a motion path, which is depicted as dotted line 205. The line is illustrated as dotted since it shows what the author intends to be the desired motion path. The dotted line is not actually seen by the viewer during playback, and may not even be displayed to the user during the authoring mode. Rather, it is shown in this embodiment of FIG. 2 to aid in illustration of the intended motion effect.

Key frame 2 220 of FIG. 2 illustrates the slide 240b at a subsequent point in time. At this time, the star object 202b is shown in the lower right corner of the slide 240b, over coordinate point (X2, Y2) 215. This is the location of the star object 202b after the motion movement has been carried out.

The description of the slide at a particular point in time is referred to as a key frame because this is an arrangement of visual objects on a slide at a given point in time. The user inherently views these key frames as describing the associated animation sequence.

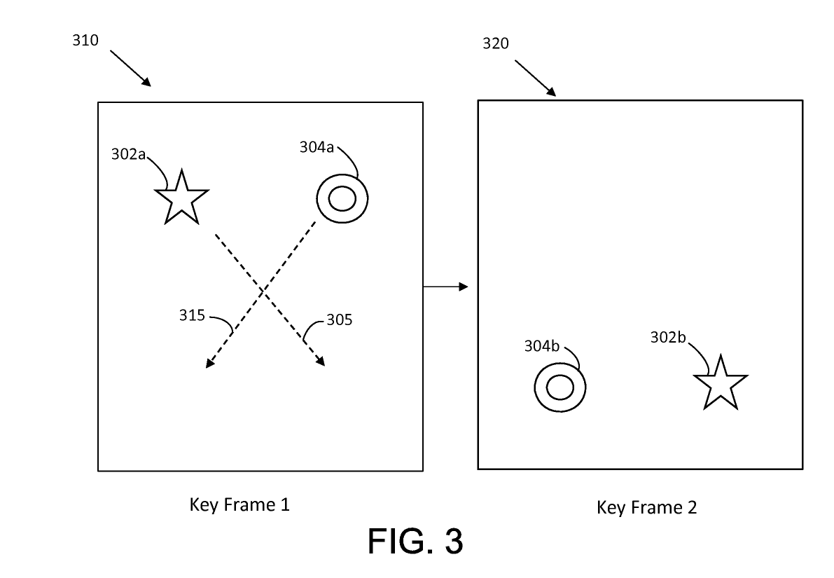

Up to this point, it has not been defined whether the slide 240a, 240b each represent the slide the user sees when authoring the animation, or the slide that the user sees when the animation is being presented. At this point, FIG. 2 or FIG. 3 could illustrate either the intended animation to be applied by the user during the authoring mode or the motion that is applied to the object during the playback mode.

The time period associated between the key frames is somewhat arbitrary. Typically, a motion animation effect lasts a few seconds. For illustration purposes, it can be assumed the time period between key frame 1 and key frame 2 is one second. Typically, when animation sequences are presented (i.e., in the playback mode), 30 frames per second (“fps”) are generated and displayed. Thus, if there is 1 second between these two key frames 210, 220, there would be 29 frames occurring between these two key frames. In each sequential frame, the star object 202 would be moved incrementally along the line 205 to its final position. The presentation program can interpolate an object's position in this case by dividing the line between the beginning coordinate point (X1, Y1) 212 to the ending coordinate point (X2, Y2) 215 into 29 equal segments and centering the object over each respective point in each frame. These interim frames between the two key frames are merely referred to herein as “frames.” The key frames are defined by the user as the starting point and ending point of the object.

Alternatively, the user could author each of the 29 frames with the star icon having a respective beginning/ending point. In this case, each of the 29 frames would be key frames, where each key frame is 1/30 of a second spaced in time from the next. In this embodiment, the presentation program would not perform any interpolation between each of these key frames. Essentially, the user is authoring the animation for each 1/30 second increments, which shifts the burden of determining the incremental movement of the object to the user. In some embodiments, the user may desire to specify this level of detail and precision. However, authoring this number of additional key frames may be tedious for the user, and the user may prefer that the presentation program somehow interpolate the intermediate frames based on the two key frames defined by key frame 1 210 and key frame 2 220.

Animation sequences can involve defining serial sequences of animation sequences as well as parallel sequences of animation sequences. FIG. 3 illustrates two key frames 310, 320 with a parallel sequence of animation. Although this illustration depicts a star object 302a, the star object 302a should be viewed as a separate application of an animation to an object relative to the star object 202a shown in FIG. 2.

In FIG. 3, the star object 302a in key frame 1 310 is located in the upper left corner of the slide and appears simultaneously with a doughnut shaped object 304a in the upper right corner. As the star object 302a moves to the diagonal corner, as shown by dotted lined 305, so does the doughnut object 304a move according to dotted line 315. The ending position is shown in key frame 2 320 with the doughnut 304b in the lower left corner, and the star object 302b in the lower right corner. Thus, both objects move simultaneously or in parallel.

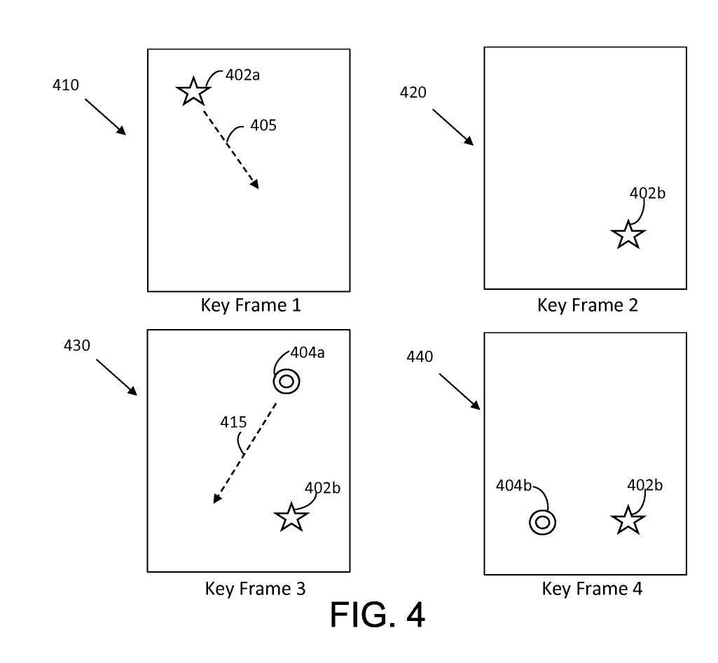

A serial sequence of animation sequences is illustrated in the key frames 410, 420, 430, and 440 of FIG. 4. Again, FIG. 4 is a distinct animation sequence from that discussed in conjunction with FIG. 3. In key frame 1 410 of FIG. 4, the star object 402a is to be moved along dotted line 405 resulting in the star object 402b positioned as shown in key frame 2 420. In key frame 3 430, the doughnut object 404a then appears (e.g., an entrance animation class type). The doughnut object 404a is to then move according to dotted line 415 with the result as shown in key frame 4 440 with the doughnut object 404b in the lower left corner along with the star object 402b.

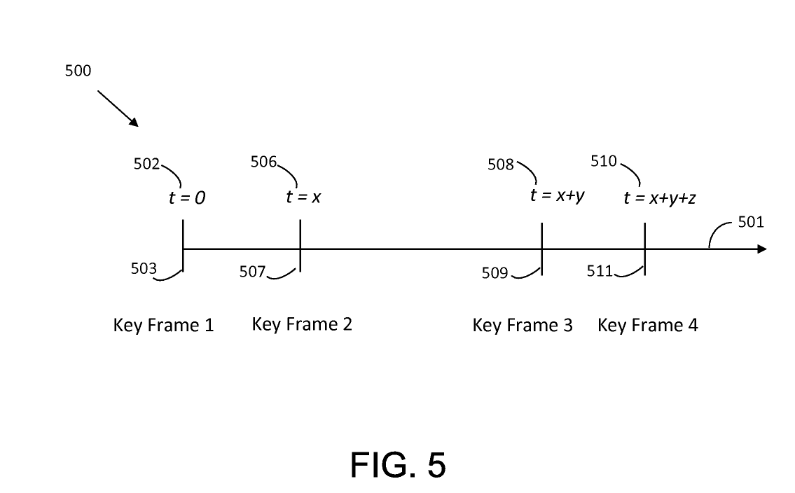

The four key frames 410, 420, 430, and 440 associated with the serial animation sequence can be illustrated using the timeline 500 representation shown in FIG. 5. FIG. 5 illustrates a timeline 501 that shows the four points in time 503, 507, 509, and 511 associated respectively with key frames 1 through key frame 4. According to this time line 500, key frame 1 503 occurs at t=0 502 which is when the star object 402a appears. The appearance of the star object 402a is coincident with the presentation of the slide in key frame 1 410 of FIG. 4. As time progresses from t=0 to t=x, the star object 402a is moving based on the presentation program interpolating its position for each frame. Once t=x arrives, which is when the second key frame 507 appears, the star object 402b ceases to move, and there are no other animations. This time period x could be defined by the user, and consistent with the prior example, it is assumed to be one second.

The user may author the presentation so that a longer period of time occurs before the doughnut 404a appears in key frame 3 430. This period of time occurs between t=x 506 and t=x+y 508, which is essentially time duration y. Assume for purposes of illustration that this is two minutes. Thus, key frame 3 509 occurs at 2 minutes, 1 second. Between key frame 3 509 and key frame 4 511, the time difference is z. For purposes of illustration, this interval is assumed to be one second. Thus, key frame 4 511 occurs at 2 minutes, 2 seconds, represented by t=x+y+z 510.

The timeline 500 is a conceptual tool for illustrating the timing of the key frames. Providing a graphical user interface illustrating this concept is useful to a user during the authoring mode, and it would not be presented during the presentation mode. During the authoring mode, various graphical user interface (“GUI”) arrangements could be used to represent the timeline. Thus, it is not necessarily that the timeline structure as illustrated in FIG. 5 is used by the presentation program. Further, the timeline structure may not be illustrated to scale to the user. Recall that the time between key frame 2 507 and key frame 3 509 is 2 minutes, which is 120 times longer than the one second between key frame 1 503 and key frame 2 507. Other arrangements may be used to represent the timeline to the user.

Using key frames facilitates authoring in that it mirrors how users often conceptualize slide layout at various points in time. In many instances, users may prefer to define the animation sequence as a series of key frames with an object positioned thereon at select times, without having to perform the tedious task of defining how every object is to be positioned at every displayed frame (e.g., at the 30 fps display rate). Thus, the user may prefer to simply define a starting key frame and an ending key frame, and then defined the time period between the two.

There is, however, a distinction between how the authoring tool in a presentation program defines the data and instructions for executing the animation sequence and how the presentation program allows the user to define the animation sequence. Referring back to FIG. 2 can illustrate the distinction. The program may simply store coordinates for the initial position (X1, Y1) 212 of the object and the final position (X2, Y2) 215, along with a time duration, (t=1 second). An interpolation engine may be invoked to generate the intermediate frames. However, there are various ways the presentation program can interact with the user to obtain this data defining the animation sequence to be performed. The program could require that the user enter a text string describing the animation sequence. While such an approach may facilitate certain programming aspects, it can place a burden on the user to learn the syntax and define the appropriate parameters.

Another approach is to define a prescriptive-oriented script which defines the actions that are to be applied to a particular visual object. This approach involves the user identifying the object in its initial position and associating an animation class type and effect to the object. Returning to the animation effect discussed in conjunction with FIG. 2, the user may select and position the star object 202a where it initially is positioned on a slide, and select a particular animation class—in this case, the motion animation class. The user would then be presented with various possible animation effects in that animation class that can be applied to the object, and the user would select the appropriate effect.

More specifically, the user could be presented with the star object 202a, and select a motion animation effect defined as “move object diagonally to the lower right.” In one embodiment, the speed at which this occurs could be fixed. While this limits the user's ability to author animation, it provides a balance between simplicity and flexibility.

However, defining a prescriptive script to be applied to objects does not necessarily comport with a user's envisioning of the star object 202a as it would exist in the first key frame 1 210 and then in the second key frame 2 220. The user may not readily know where the ending position is for the animation effect to “move object diagonally to the lower right.” Further, it becomes evident that a different prescriptive script is required to move the object in each direction. Providing increasing flexibility comes with the cost of decreasing simplicity. Thus, while a user may envision animation as involving the layout of objects on the screen at different sequential times (e.g., key frames), a prescriptive-oriented script may not always dovetail with that view.

This disparity becomes further evident when considering serial animation sequences, such as the key frames discussed in FIG. 4. Recall in that sequence, a serial animation sequence was defined in which the star object 402a moves diagonally first. Then, after it stops, the doughnut object 404a appears and moves diagonally. A prescriptive-oriented approach may presenting each of the objects in their initial position in a single slide along with providing animation descriptors about when and how each object appears.

The user might be presented with a display screen depicting the animated objects in their initial starting position. However, doing so does not by itself conveniently reflect that the objects are animated serially. While this may be conveyed by a script, it can be difficult for the user to comprehend that one animation begins after another ends by reviewing the script. This illustrates the challenges of presenting serial animation for a slide by showing a single slide image with all the objects.

The animation script, also referred to as a prescriptive-oriented description, is generated by some existing presentation programs, and offers the advantage of allowing data describing the animation to be stored with the slide and executed later when viewing the presentation in the playback mode. This avoids, for example, having to generate and store individual animation frames during the authoring mode which can significantly increase storage requirements. Using a prescriptive-oriented description approach allows presentation of the slide without having to generate and store the intermediate frames before presenting the slide.

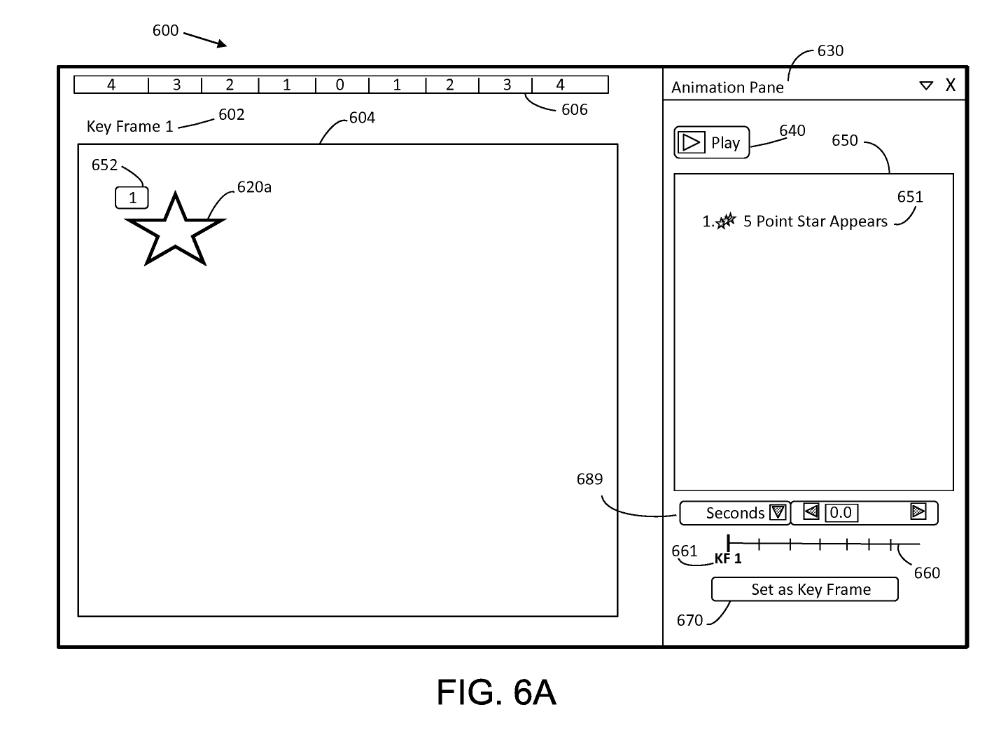

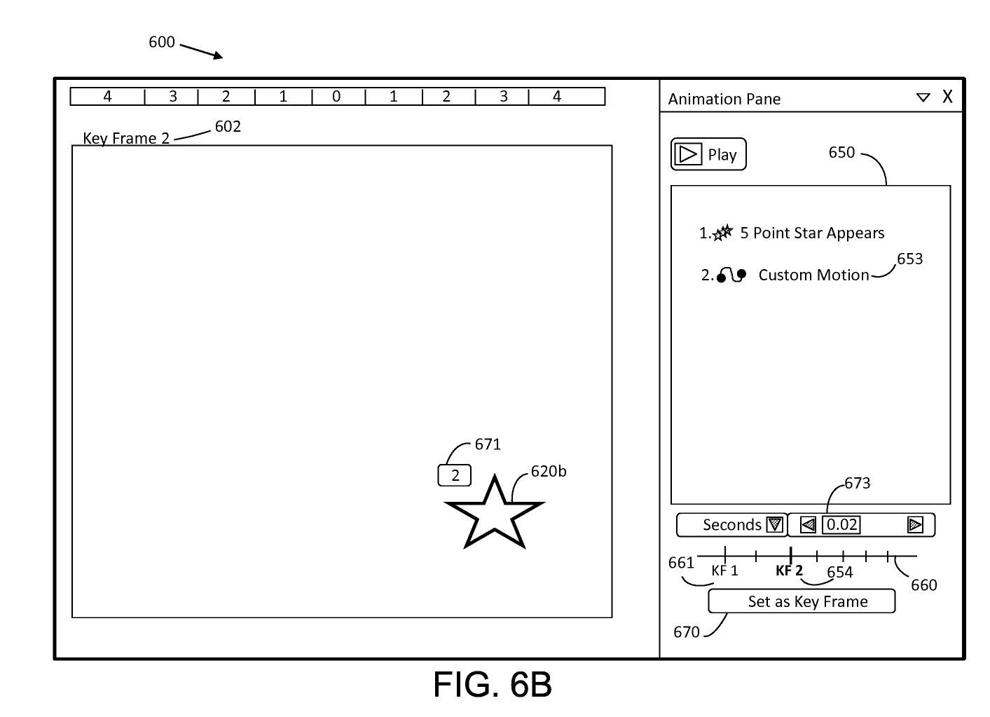

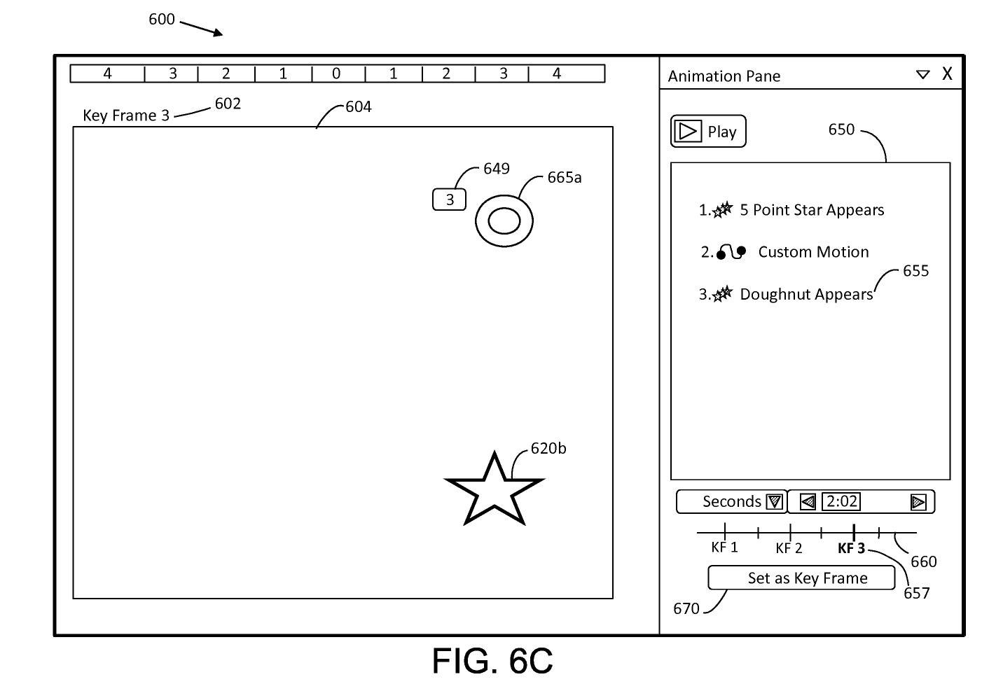

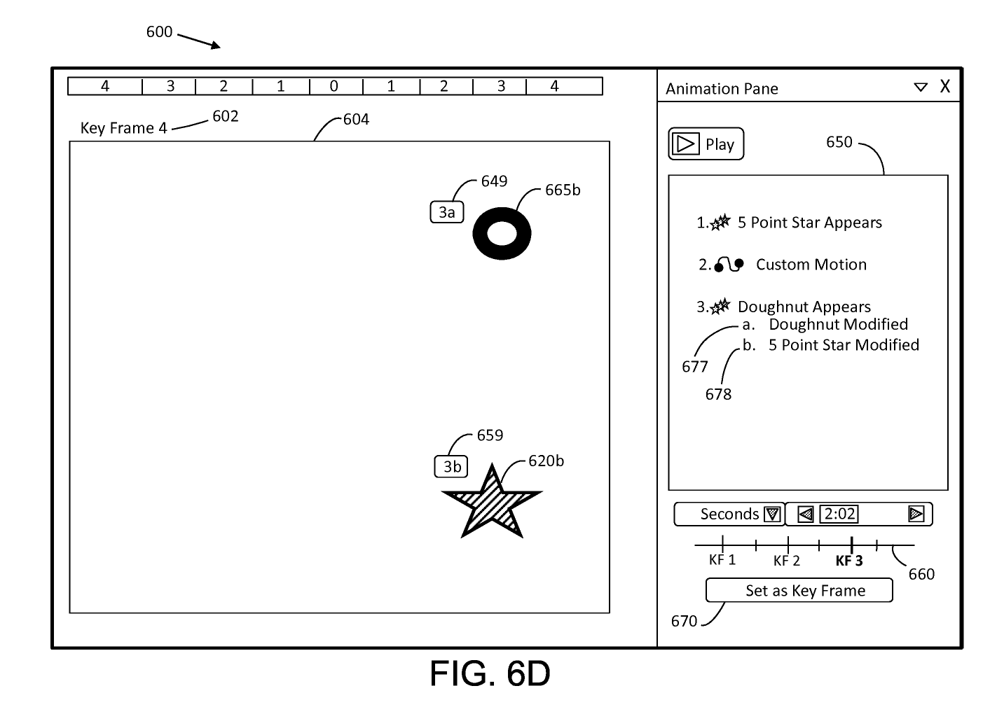

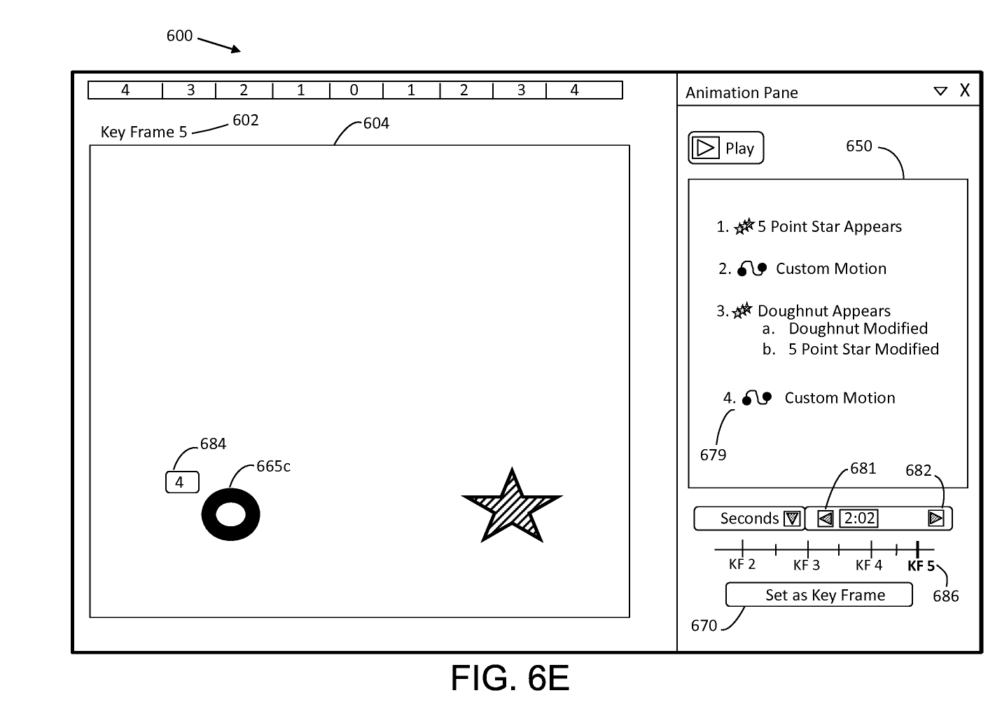

It is possible to integrate aspects of the prescription-oriented scripting approach for defining animation with the concept of key frames. One embodiment of integrating the concept of key frames and direct manipulation of object with a prescriptive-oriented description is shown in FIGS. 6A-6E. This approach allows a user to define key frames and further manipulate the objects on the key frames using various currently available editing tools. Once the objects are manipulated and a key frame is defined, the presentation program in real-time generates the associated prescriptive-oriented description of desired animation. Thus, an improved authoring interface for the authoring mode is provided that generates data that can be executed by another version of a presentation program in the playback mode that does not have the authoring tool.

FIGS. 6A-6E illustrate a user-interface based on the four key frames shown in FIG. 4. More specifically, these examples in FIGS. 6A-6E include the animation sequence illustrated by FIG. 4 with the addition of one other animation effect for the sake of illustrating another animation class type. In these examples, a progression of key frames are defined where objects may be introduced and manipulated. After objects are introduced and manipulated into a desired configuration, the indication of a new key frame can build upon the latest configuration of objects as the starting point for the new key frame. This facilitates the user creating the overall results in that the user does not have to replicate the object and their configuration each time a subsequent key frame is indicate. Of course, in some embodiments (not shown in FIGS. 6A-6E), the user may desire to remove all the objects and define new objects when defining the new key frame.

Turning to FIG. 6A, a GUI 600 of the presentation program associated with the authoring phase is shown. This could be presented on a local computing device, such as a tablet computer, laptop computer, smart phone, desktop computer or other type of processing device. In another embodiment, the GUI could be generated by an application program by a server in a cloud computing environment that is accessed using a local processing device, such as disclosed in FIG. 1.

In one embodiment, the GUI comprises a ruler 606 which aids the user in placement of objects in an editing window pane 604. The editing pane 604 presents the objects in the document (e.g., a slide) that will be provided on display screen during another mode (e.g., the presentation mode). A text based key frame indicator 602 is provided in text form for the purpose of indicating to the user the current key frame being viewed. A slide number indicator (not shown) may also be provided to the user. A timeline 660 is presented, and it has another form of a key frame indicator indicating the current key frame 1 (“KF 1”) 661. An animation pane 630 is used to provide the prescriptive-oriented description information (animation descriptors) in an animation script pane 650. Various controls, such as a PLAY control 640 may be provided in the animation panel 630, as well as an indicator 670 for requesting setting a new key frame. Other controls, such key frame time controls 689 are discussed below and used to inform and control the time between key frames. These embodiments are only illustrative, as there are various other GUI type tools that could be used in addition, or in lieu of, the controls shown.

In the editing pane 604 a star object 620a is shown. Its relative position in the editing panel 604 is as shown and is intended to correlate with the position of the star object 402a in key frame 1 410 of FIG. 4. Based on timeline 660, it is evident that a single key frame is defined for the current slide. The animation script pane 650 indicates that the first animation sequence involves the appearance of a 5 point star 651. A corresponding numerical label 652 appears next to the associated star object 620a. Thus, the user knows that the star object 620a is linked to the animator descriptor 651 by virtue of the numerical label 652.

Because the animation effect is associated with the appearance of an object, the animation effect is an “entrance” animation class type. The user may have implicitly indicated this by first indicating that an animation sequence is to be defined and then dragging and dropping the star object 620a on the editing pane 604, or otherwise pasting the star object 620a into the editing pane 604. The user action of inserting or otherwise adding the star object 620a can be mapped by the presentation program to the entrance animation class. In some embodiments, the program may default by applying a particular animation effect in that class, and the user may be able to alter the animation effect based on a menu selection option, a command, etc. Thus, the presentation program may default to a certain entrance class animation effect, and the user could alter the animation effect to another type, so that the star object 620a can fade-in, fly-in, etc.

Once the initial position of the star object 620a is as desired, the user can select the “set key frame” icon 670 which sets the location of the object in the key frame. The presentation program then indicates the animation effect for the current key frame. In this case, the current key frame is key frame 1 661 as indicated on the time line 670 and as well as the text version of the key frame indicator 602.

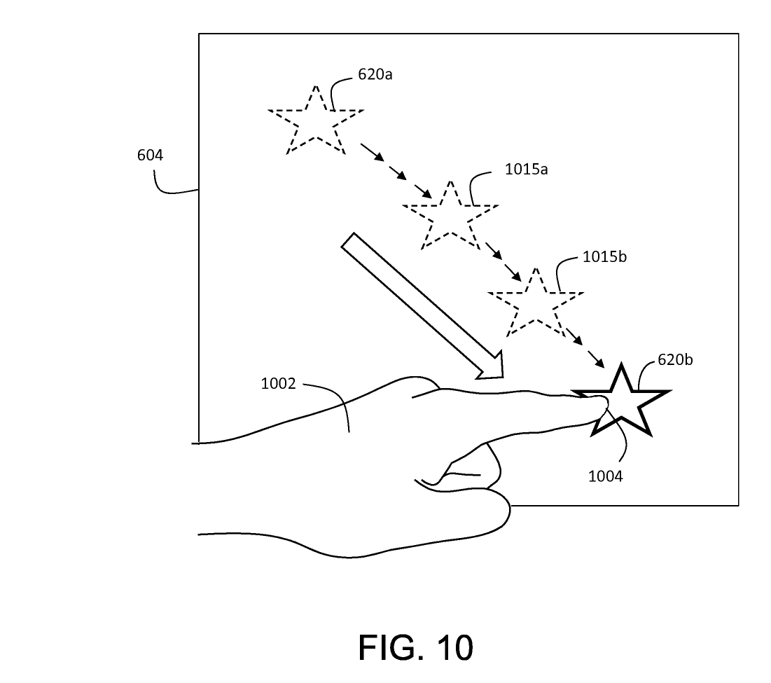

The user may then use the mouse, touch screen, or other type of pointing device to select the star object 620b and drag it to a desired location. In one embodiment, the user can select and drag the object using their finger as shown in FIG. 10. FIG. 10 depicts the editing pane 604 on a touch screen, such as may be provided on a tablet computing device. The user's left hand 1002 is depicted as directly manipulating the object 620a from its original position 620a to its final position 620b. This is accomplishing by touching the object to select it, and then using the finger 1004 to drag the object through a series of intermediate positions 1015a, 1015b, to the final position. This type of manipulation is a form of “direct manipulation” because the user directly selects and moves the star object 620b consistent with the desired animation sequence that is to occur.

Once the object is at the final location, the updated GUI 600 of FIG. 6B is provided to the user. Once the user is satisfied with the location of the star object 620b and selects icon 670 to set the key frame (this time the presentation program recognizes this as key frame 2 654, 602), the program ascertains the animation class and effect, which in this case is a motion path. This is reflected in the animation script pane 650 as the second prescriptive animation descriptor 653, namely that a custom motion has been defined. A corresponding numerical label 671 is generated adjacent to the star object 620b to aid the user in associating the star object 620b with the prescriptive animation descriptor 653 in the animation descriptor pane.

At the same time, the timeline 660 is updated to show that this is the second key frame 654. Each “tick” on the time line 660 can be defined to represent a certain time period by default, which in one embodiment can be 0.5 (one half) second. Thus, key frame 2 654 is shown as occurring one second after key frame 1 661. This means that the motion path indicated by key frame 1 661 and key frame 2 654 will involve a single second time span, which at 30 fps, is 30 frames. There is no need for the user to have to individually create and define the object's position for 30 key frames (although the user can define this, if desired). Rather, the presentation program will interpolate the object's location as required for each intermediate frame. Similarly, the text description 602 of the current key frame being viewed is updated. The time relative to the presentation of the slide at which the current key frame occurs can also be indicated using another form of GUI icon 673. In this embodiment, the GUI icon 673 indicates key frame 2 654 occurs at zero minutes and two seconds (“0.02”) after the slide is initially presented. In other embodiments, the time indicated could be cumulative of the time of the overall presentation (e.g., taking into account previous slides).

The updated GUI 600 of FIG. 6C represents the next animation sequence, which occurs after the animation sequence involving the animation of the star object 620b completes in FIG. 6B. In this sequence, shown in FIG. 6C, another object 665a is added, which is another example of the entrance animation class type. In FIG. 6C, the doughnut object 665a appears on the editing pane 604. The doughnut object 665a can be placed there by using any of the existing GUI tools, such as a “copy/paste” command or selecting an “insert” menu function. As noted before, this can occur using a mouse, touch-screen, or other pointing means. The presentation program interprets this action as an entrance animation class type and generates a third prescriptive animation descriptor entry 655 in the animation script pane 650. After selecting the set key frame icon 670, the timeline 660 is updated by emphasizing the “KF 3” indicator 657. Further the text key frame indicator 602 is updated and a corresponding numerical label 649 is added adjacent to the doughnut object 665a that corresponds to the animation descriptor 655.

For the sake of illustration, an additional animation relative to the sequence disclosed in conjunction with FIG. 4 is provided. Recall that FIG. 4 only involved motion paths and did not involve any “emphasis” animation class types. Thus, an “emphasis” animation class type effect will be added.

In FIG. 6D, an “emphasis” animation class type effect is added to the two objects as shown in the updated GUI 600. In this embodiment, the user desires to fill the doughnut object 665b with a solid color, and add a pattern to the star object 620b. This is accomplished by the user selecting the respective object and altering the fill pattern using well known techniques that are available on presentation programs (not shown in FIG. 6D). Once the changes are as desired, the set key frame icon 670 is selected, and the presentation program updates the animation descriptors 677, 678 in the animation script pane 650 by indicating the objects have been modified. A corresponding numerical label 659 is added to the star object 620b and the numerical label 649 associated with the doughnut object 665b is updated. Each label corresponds to the respective animation descriptor 677, 678. In addition, the text based key frame indicator 602 and the time line 660 is updated to reflect the new key frame. In other embodiments, the emphasis effect added could be shrinking/expanding the icon, changing color, bolding text, etc.

In the final updated GUI 600 comprising key frame 5 602 shown in FIG. 6E, the user desires to move the doughnut 665b from the upper right corner to the lower left corner. Again, this is accomplished by direct manipulation, by selecting and dragging the object. FIG. 6E shows the doughnut object 665c in its final location. As discussed previously, the direct manipulation can occur by the user touching and dragging the object in the editing pane on a touch screen of a mobile processing device. The presentation program again recognizes this action, interprets it as a “motion path” animation class type effect, and indicates the corresponding animation descriptor 679 in the animation script pane 650. Once the set key frame icon 670 is selected, the presentation program places a numerical label 684 adjacent to the object 665c that reflects the associated added animation descriptor 679. In addition, the text box key frame indicator 602 and the timeline 660 are updated to reflect the new key frame number 686.

The user can scroll through the various key frames using controls 681, 682 or other types of GUI controls not shown. A variety of mechanisms can be defined to indicate, select, modify, and define the time duration between key frames.

The user can at any time during the process of defining the animations, request to view the resulting animation. In other words, the animation script for the latest key frame can be executed and presented to the user. For example, after the user has defined the animation shown in FIG. 6E, the user could request to view the animation leading to the current point. After the animation is presented, the user interface reverts to that as shown in FIG. 6E. That arrangement of the contents of editing pane is then ready to serve as the basis for the next key frame, if the user so chooses to define another key frame.

The above example illustrates how direct manipulation could be used to create an animation for an object. The above concepts can be applied to editing an existing animation. In the above example, editing an animation can be accomplishing by selecting the desired key frame, entering an editing mode, and altering the animation. For example, the final position of an object can be altered using the aforementioned direction manipulation techniques.

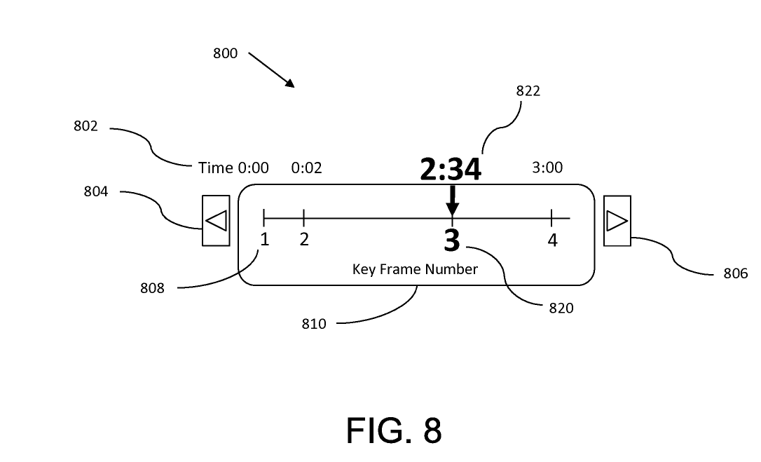

For example, turning to FIG. 8, an alternative GUI is illustrated informing the user regarding the number of key frames, the time between key frames, and provides controls for editing the time between key frames. The GUI 800 of FIG. 8 is another means for informing the user of the current key frame number as indicated by the bold number 820 on the numerical key frame number line 808 in the sliding key frame indicator 810. The user can navigate using controls 804, 806 to increase or decrease the current key frame number. A time bar 802 is also provided that indicates the relative time position of the key frames. For example, key frame 3 820 is associated with a time indicator 822 that states a time of 2:34 (2 minutes and 34 seconds). This could be defined as the time of the key frame within a given slide, or in the context of the overall presentation, including all previous slides. Other forms of GUI may supplement the information provided.

In this manner, the presentation program can provide an additional, or different, authoring interface for a user to author animations for an object on a slide. The user can define key frames which represent different times and screen layouts for that slide. As the user defines the key frames, the program creates a prescriptive descriptor based on a set of animation primitives. The user can also define when these key frames are to occur. When these animation primitives are executed during the presentation mode in conjunction with the visual display object, the animations are recreated.

Although the user is creating key frames at specific times, the user does not have to generate a key frame for every frame, but can rely and control how interpolation occurs by the presentation program.

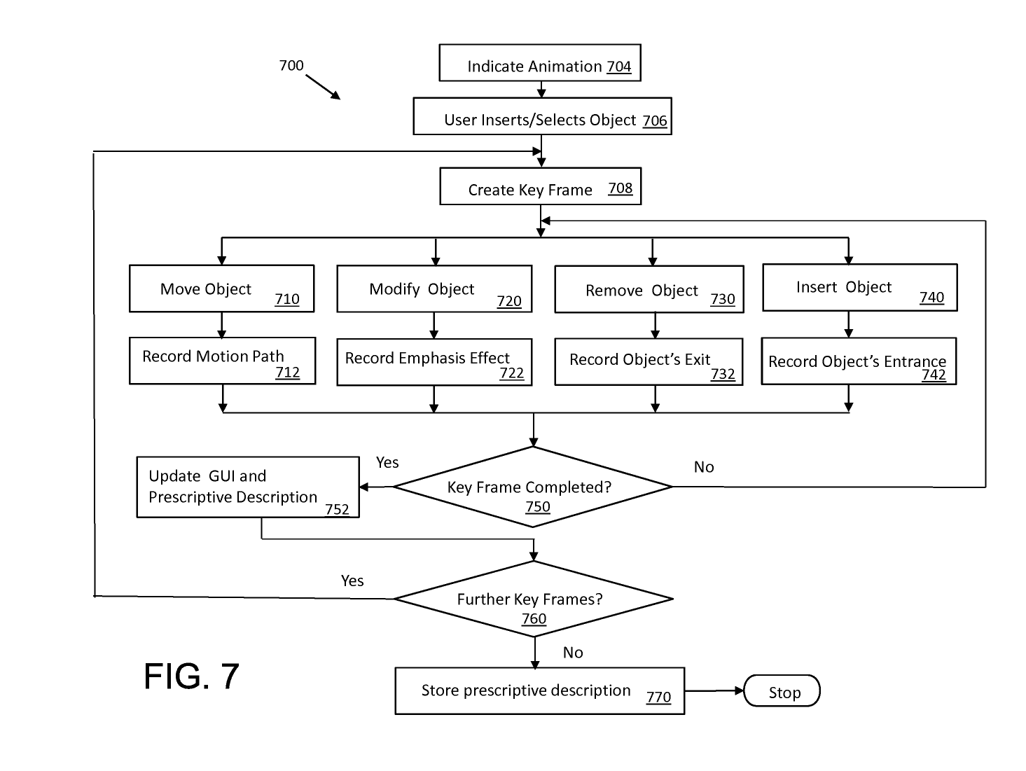

The process for creating a key frame and generating the associated prescriptive descriptor is shown in one embodiment in FIG. 7. It should be appreciated that the logical operations described herein with respect to FIG. 7 and the other FIGURES are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof. It should also be appreciated that more or less operations may be performed than shown in FIG. 7 and described herein. These operations may also be performed in a different order than those described herein.

FIG. 7 illustrates the process 700 beginning in operation 704 with the presentation program receiving an animation indication from the user. This indicates that an animation sequence is to be defined and applied to an existing object, or to an object that the user will identify and insert. This indication distinguishes the context between inserting or editing a static object, versus defining an animation for an object.

In operation 706, the user is presumed to have inserted an object for animation. Once the location and characteristics of the object are satisfactory to the user, an indication is received from the user setting the key frame in operation 708. Typically, there is at least one object in a key frame required in order to initiate an animation, since an animation sequence operates on an object.

After the initial key frame is established in operation 708, the user can then exercise various options to indicate an animation effect. One or more of these effects can be indicated in a key frame. In operation 710, an object can be moved by the user via direct manipulation, e.g., by dragging the desired object to its ending location using a mouse, touch screen, or other pointing means. The actual motion path of the object could be recorded, or the final destination location could be recorded and the path interpolated. In either case, the presentation program in operation 712 records the desired information in association with a “motion path” animation class type. A default type of animation effect within this class can be applied, and this animation effect can be modified. The particular effect to be applied can be indicated using a menu, command, or other means.

In operation 720, the user may modify a selected object. This can be accomplished by using the cursor to select the object and fill it with a selected pattern, alter the object's color, or select some other effect that should be applied using conventional techniques. In operation 722, the presentation program interprets this action as an “emphasis” animation class type.

In operation 730, the user may remove an object. This can be done by selecting the object and deleting it using a specified function key (“Delete”), functional icon, menu option, cutting it, etc. The user may further indicate what particular animation effect is to occur when the object is removed. The program in operation 732 interprets this as an “exit” animation class type.

Finally, in operation 740, the user may insert an object into the key frame. This can occur using the drag-and-drop capability, an object insertion function, a paste function, or some other function that inserts an object into the key frame. In operation 742, the presentation program interprets the object insertion action as an “entrance” animation class type.

The user may define a number of animation sequences in parallel and once completed, this is indicated in operation 750. This may be indicated by selecting a dedicated function icon as previously disclosed. Once the key frame is set or finalized, the program can then display the correlated prescriptive descriptor associated with the animation sequences.

In one embodiment, the prescription oriented script is formed in a backwards compatible manner with presentation programs that do not incorporate the direct manipulation authoring feature. Thus, the direct manipulation authoring tool does not necessarily define any new capabilities with respect to the primitives in the prescriptive script, but provides an alternative method for authoring animations. If further operations are required, the process proceeds from operation 750 back to one of the options 710, 720, 730, or 740.

If the key frame is completed in operation 750, the process flow continues to operation 752. This operation updates the GUI with the updated key number information, updated animation primitive descriptor, and stores the prescription animation script associated with the object.

Once this is completed, then operation 760 occurs which determines if there are further key frames to be defined for the current slide. If the animation effect involves motion, then the user will typically generate at least two key frames for a slide. If only an emphasis or an entrance effect is required, then the user can generate a single key frame for the slide.

If no further key frames are to be generated, then the process continues to operation 770 where the prescriptive animation script is stored in association with the slides and the process is completed. Otherwise, the process continues from operation 760 to operation 708 where another key frame is created.

The resulting output is a file that comprises data structures including the visual objects associated with each slide and each object's prescriptive animation script. The resulting file can be executed by the program to present the slideshow and it is not necessary for the program to even incorporate an authoring tool, or the same type of authoring tool as disclosed above.

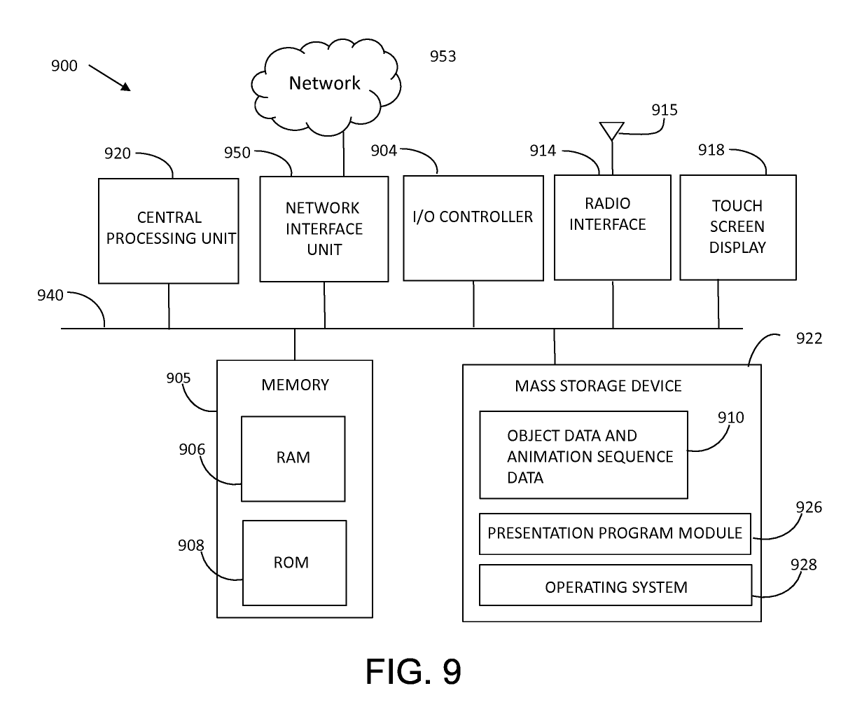

An embodiment of the computing architecture for the server for accomplishing the above operations is shown in FIG. 9. FIG. 9 shows an illustrative computing architecture 900 for a computing processing device capable of executing the software components described. The computer architecture shown in FIG. 9 may illustrate a conventional server computer, laptop, table, or other type of computer utilized to execute any aspect of the software components presented herein. Other architectures or computers may be used to execute the software components presented herein.

The computer architecture shown in FIG. 9 includes a central processing unit 920 (“CPU”), a system memory 905, including a random access memory 906 (“RAM”) and a read-only memory (“ROM”) 908, and a system bus 940 that couples the memory to the CPU 920. A basic input/output system containing the basic routines that help to transfer information between elements within the server 900, such as during startup, is stored in the ROM 908. The computer 900 further includes a mass storage device 922 for storing an operating system 928, application programs, and other program modules, as described herein.

The mass storage device 922 is connected to the CPU 920 through a mass storage controller (not shown), which in turn is connected to the bus 940. The mass storage device 922 and its associated computer-readable media provide non-volatile storage for the computer 900. Although the description of computer-readable media contained herein refers to a mass storage device, such as a hard disk or CD-ROM drive, it should be appreciated by those skilled in the art that computer-readable media can be any available computer storage media that can be accessed by the computer 900.

By way of example, and not limitation, computer-readable media may include volatile and non-volatile, removable and non-removable media implemented in any method or technology for storage of information such as computer-readable instructions, data structures, program modules or other data. For example, computer-readable media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer 900.

According to various embodiments, the computer 900 may operate in a networked environment using logical connections to remote computers or servers through a network such as the network 953. The computer 900 may connect to the network 953 through a network interface unit 950 connected to the bus 940. It should be appreciated that the network interface unit 950 may also be utilized to connect to other types of networks and remote computer systems.

The computer 900 may also incorporate a radio interface 914 which can communicate wirelessly with network 953 using an antenna 915. The wireless communication may be based on any of the cellular communication technologies or other technologies, such as WiMax, WiFi, or others.

The computer 900 may also incorporate a touch-screen display 918 for displaying information and receiving user input by touching portions of the touch-screen. This is typically present on embodiments based on a tablet computer and smart phone, but other embodiments may incorporate a touch-screen 918. The touch screen may be used to select objects and define a motion path of the object by dragging the object across the editing pane.

The computer 900 may also include an input/output controller 904 for receiving and processing input from a number of other devices, including a keyboard, mouse, or electronic stylus (not shown in FIG. 9). Similarly, an input/output controller may provide output to a display screen, a printer, or other type of output device (also not shown in FIG. 9). The input/output controller may also provide an interface to an audio device, such as speakers, and/or an interface to a video source, such as a camera, or cable set top box, antenna, or other video signal service provider.

As mentioned briefly above, a number of program modules and data files may be stored in the mass storage device 922 and RAM 906 of the computer 900, including an operating system 928 suitable for controlling the operation of a networked desktop, laptop, tablet or server computer. The mass storage device 922 and RAM 906 may also store one or more program modules or data files. In particular, the mass storage device 922 and the RAM 906 may store the prescription animation script data 910. The same storage device 922 and the RAM 906 may store the presentation program module 926 which may include the direct manipulation authoring capabilities. The prescription animation script data 910 can be transferred and executed on other systems which also have the presentation program module 926, but in this case, the prescription animation script data 910 can be executed even if the direction manipulation authoring capabilities in not present in the presentation program. The mass storage device 922 and the RAM 906 may also store other types of applications and data.

It should be appreciated that the software components described herein may, when loaded into the CPU 920 and executed, transform the CPU 920 and the overall computer 900 from a general-purpose computing system into a special-purpose computing system customized to facilitate the functionality presented herein. The CPU 920 may be constructed from any number of transistors or other discrete circuit elements, which may individually or collectively assume any number of states. More specifically, the CPU 920 may operate as a finite-state machine, in response to executable instructions contained within the software modules disclosed herein. These computer-executable instructions may transform the CPU 920 by specifying how the CPU 920 transitions between states, thereby transforming the transistors or other discrete hardware elements constituting the CPU 920.

Encoding the software modules presented herein may also transform the physical structure of the computer-readable media presented herein. The specific transformation of physical structure may depend on various factors, in different implementations of this description. Examples of such factors may include, but are not limited to the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software may also transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations may also include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer 900 in order to store and execute the software components presented herein. It also should be appreciated that the computer 900 may comprise other types of computing devices, including hand-held computers, embedded computer systems, personal digital assistants, and other types of computing devices known to those skilled in the art. It is also contemplated that the computer 900 may not include all of the components shown in FIG. 9, may include other components that are not explicitly shown in FIG. 9, or may utilize an architecture completely different than that shown in FIG. 9. For example, some devices may utilize a main processor in conjunction with a graphics display processor, or a digital signal processor. In another example, a device may have an interface for a keyboard, whereas other embodiments will incorporate a touch screen.

Based on the foregoing, it should be appreciated that systems and methods have been disclosed for providing an authoring tool for a presentation program where the user can indicate animation sequences by using direct manipulation of objects in a key frame. It should also be appreciated that the subject matter described above is provided by way of illustration only and should not be construed as limiting. Although the concepts are illustrated by describing a slide presentation program, the concepts can apply to other types of applications. These include web based applications allowing animations to be defined for one or more objects when viewed on a browser. Thus, use of terms such as a “document” or “editing pane” should not be interpreted as limiting application of the concepts to only a slide presentation program.

Various modifications and changes may be made to the subject matter described herein without following the example embodiments and applications illustrated and described, and without departing from the true spirit and scope of the present invention, which is set forth in the following claims.

1. A method of defining an animation sequence comprising:
providing an editing pane and an animation script pane to a user via a graphical user interface on a computing device;
receiving input from the user identifying an object to which the animation sequence is to be applied to;
receiving input from the user manipulating the object within the editing pane;
interpreting manipulation of the object as one of a plurality of animation class types;
receiving input from the user requesting setting a first key frame; and
updating the animation script pane by providing an animation descriptor of the animation sequence to be applied to the object when the object is animated.

2. The method of claim 1, wherein receiving input from the user identifying the object comprises receiving input over a communications network from the computing device.

3. The method of claim 1, wherein receiving input from the user manipulating the object within the editing pane comprises deleting the object on the editing pane, and
interpreting manipulation of the object as one of a plurality of animation class types comprises interpreting the input from the user manipulating the object as an exit animation class type.

4. The method of claim 1, further comprising:
providing the user with a set of animation effects based on the one of a plurality of animation class types interpreted based on manipulation of the object.

5. The method of claim 4, further comprising:
receiving an input from the user selecting an animation effect from the set of animation effects.

6. The method of claim 1, wherein receiving input from the user manipulating the object within the editing pane comprises inserting the object into the editing pane and the associated animation class type is interpreted as an entrance animation class type.

7. The method of claim 6, further comprising:
receiving another input from the user manipulating the object within the editing pane comprising moving the object within the editing pane and wherein an animation class type associated with the another input is interpreted as a motion path animation class type.

8. The method of claim 1, further comprising:
interpreting a second input from the user manipulating the object as another one of a plurality of animation class types;
receiving a second input from the user requesting setting a second key frame;
providing the editing pane comprising the object;
receiving further input manipulating the object; and
updating the animation script pane by providing another animation descriptor of the animation sequence to be applied to the object when the object is animated.

9. The method of claim 8, further comprising:
receiving a third input from the user altering a time period between the first key frame and the second key frame.

10. The method of claim 9, further comprising:
updating the animation script pane by providing a time associated with the second key frame.

11. A computer-readable storage medium having computer-readable instructions stored thereupon which, when executed by a computer, cause the computer to:
provide an editing pane and an animation script pane to a user via a graphical user interface on a computing device;
receive a first input identifying an object to which an animation sequence is to be applied to;
receive a second input manipulating the object within the editing pane;
interpret the second input manipulating the object as one of a plurality of animation class types;
receive a third input requesting a setting of a first key frame; and
update the animation script pane by providing an animation descriptor of the animation sequence to be applied to the object.

12. The computer-readable storage medium of claim 11, wherein the instructions further cause the computer to:
receive further input manipulating the object within the editing pane comprising deleting the object on the editing pane, and
interpret the further input manipulating the object as an exit animation class type.

13. The computer-readable storage medium of claim 12, wherein the instructions further cause the computer to:
update the animation script pane by indicating an exit animation class type associated with the object.

14. The computer-readable storage medium of claim 13, wherein the instructions further cause the computer to:
update a graphical user interface by indicating a numerical key frame number on a key frame timeline.

15. The computer-readable storage medium of claim 11, wherein the instructions further cause the computer to:
receive further input manipulating the object within the editing pane comprising inserting a second object into the editing pane and the animation script pane is updated to reflect an entrance animation class type associated with the second object.

16. A system for defining an animation sequence of an object comprising:
a network interface unit connected to a communications network configured to receive user input from a computer pertaining to defining the animation sequence;
a memory configured to store data representing the object to which the animation sequence is to be associated with; and
a processor configured to:
provide an editing pane and an animation script pane to the user,
receive a first input identifying the object to which the animation sequence is to be applied to,
receive a second input manipulating the object within the editing pane,
interpret the second input manipulating the object as one of a plurality of animation class types,
receive a request requesting setting a first key frame,
in response to receiving the request, update the animation script pane by indicating a first animation descriptor of the animation sequence to be applied to the object when the object is animated,
interpret a third input manipulating the object as another one of a plurality of animation class types,
receive another request requesting setting a second key frame, and
in response to receiving the another request, update the animation script pane (650) by providing a second animation descriptor of the animation sequence to be applied to the object.

17. The system of claim 16, wherein the second input comprises the user manipulating the object within the editing pane by moving the object from a first location to a second location,
wherein the processor is configured to interpret moving the object from the first location to the second location as a motion path animation class type, and
the processor is further configured to update the animation script pane by indicating the motion path animation class type.

18. The system of claim 17, wherein the processor is further configured to:
provide a set of animation effects that can be applied to the object based on the one of a plurality of animation class types,
receive a selection selecting an animation effect from the set of animation effects, and
in response to receiving the selection, update the animation script pane by indicating the selected animation effect is associated with the object.

19. The system of claim 18, wherein the processor is configured to:
provide on a graphical user interface a time associated with the second key frame in the animation script pane.

20. The system of claim 19, wherein the processor is further configured to:
receive input to alter a time period between the first key frame and the second key frame.
